(19) United States
(12) Patent Application Publication
(10) Pub. No.: US 2026/0184262 A1
(43) Pub. Date: Jul. 2, 2026

(54) FRUNK ASSEMBLY

(71) Applicants: Hyundai Motor Company, Seoul (KR); Kia Corporation, Seoul (KR)

(72) Inventors: Yeong Jae Kim, Hwaseong-si (KR); Joong Hyun Shin, Hwaseong-si (KR); Jung Hwan Noh, Gyeongsan-si (KR); Tae Min Lee, Gyeongsan-si (KR)

(21) Appl. No.: 19/175,401

(22) Filed: Apr. 10, 2025

(30) Foreign Application Priority Data
Dec. 30, 2024 (KR) 10-2024-0199535

(51) Int. Cl. B60R 5/02; B62D 25/08

(52) U.S. Cl. CPC B60R 5/02; B62D 25/087

(57) ABSTRACT

A frunk assembly can includes an upper member disposed on an upper portion of a front end module for a vehicle, a plate portion disposed to have a step portion with an upper surface of the upper member, and a tray having an opening disposed at the front thereof, wherein a lower portion of the tray is coupled to the plate portion, wherein a back portion of the upper member facing the opening is bent toward the front of the upper member, and wherein the back portion of the upper member and the tray form a receiving portion.

### CROSS-REFERENCE TO RELATED APPLICATIONS

This application claims the priority and benefit of Korean Patent Application No. 10-2024-0199535, filed on Dec. 30, 2024 with the Korean Intellectual Property Office, the disclosure of which is incorporated herein by reference.

### TECHNICAL FIELD

The present disclosure relates to a frunk assembly for a vehicle.

### BACKGROUND

In a vehicle design, securing storage space considering user convenience and efficiency is becoming increasingly important. In particular, an electric and hybrid vehicle may secure storage space by utilizing space previously occupied by an engine in a conventional internal combustion engine vehicle. One of such storage spaces is a frunk, which is disposed at the front of the vehicle and may be used to store luggage.

However, an existing frunk structure may have problems such as ineffective use of limited space and increased complexity and cost during a vehicle assembly process. There may be cases in which waterproof and dustproof functions of a storage portion may not be sufficiently secured, reducing user satisfaction.

### SUMMARY

To solve at least a portion of the above-described problems, a frunk assembly according to an embodiment of the present disclosure can improve a frunk structure to efficiently utilize the limited space in front of the vehicle.

The purpose of an embodiment of the present disclosure is not necessarily limited to the purpose mentioned above, and other advantages not mentioned herein can be clearly understood by those skilled in the art from the description below.

According to an embodiment of the present disclosure, a frunk assembly can include: an upper member disposed on an upper portion of a front end module for a vehicle; a plate portion disposed to have a step portion with an upper surface of the upper member; and a tray having an opening disposed at the front thereof, wherein a lower portion of the tray is coupled to the plate portion, a back portion of the upper member facing the opening is bent toward the front of the upper member, and the back portion of the upper member and the tray form a receiving portion.

The end of the lower portion of the tray can be spaced apart from at least a portion of the back portion in a first direction, wherein the first direction is a direction intersecting a longitudinal direction of the upper member.

A lower surface of the lower portion of the tray can be in contact with an upper surface of the plate portion.

The back portion can include a wall structure.

A rib protruding toward the front of the back portion can be disposed in the back portion.

The tray can include a side wall portion, and the back portion and the side wall portion can form an inner surface of the receiving portion.

The upper surface of the plate portion can include: a first upper surface; and a second upper surface disposed at the rear of the first upper surface and forming a step portion with the first upper surface, wherein the lower portion of the tray is coupled to the second upper surface.

A sealing member having elasticity can be included, wherein the sealing member can be disposed along the periphery of the receiving portion.

A protrusion extending along the periphery of the receiving portion, and into which the sealing member is fitted and coupled can be included.

According to an embodiment of the present disclosure, a frunk assembly can include: an upper member disposed on an upper portion of a front end module for a vehicle; and a tray disposed facing the upper member and coupled to the front end module, wherein the upper member includes a first member; a second member disposed on one side of the first member; and a third member disposed on the other side of the first member, and space between the first member, the second member, and the third member forms a receiving portion together with the tray.

The first member and the second member can be disposed at an obtuse angle, and the first member and the third member can be disposed at an obtuse angle.

A joint portion of the tray and the front end module can be lower than the upper surface of the upper member.

### BRIEF DESCRIPTION OF THE DRAWINGS

The above and other features and advantages of example embodiments of the present disclosure can be more clearly understood from the following detailed description taken in conjunction with the accompanying drawings, in which:

FIG. 1 is a diagram of a frunk assembly according to an embodiment of the present disclosure viewed obliquely;

FIG. 2 is a diagram of a frunk assembly according to an embodiment of the present disclosure viewed from above;

FIG. 3 is an exploded diagram of a frunk assembly according to an embodiment of the present disclosure;

FIG. 4 is an enlarged diagram of an upper portion of the front end module in FIG. 3;

FIG. 5 is a diagram of a part of the upper member of the front end module of FIG. 3 viewed from above;

FIG. 6 is a diagram of the tray according to an embodiment of the present disclosure viewed obliquely;

FIG. 7 is a diagram of a tray according to an embodiment of the present disclosure, viewed obliquely from a different angle than FIG. 6;

FIG. 8 illustrates a cross-section I-I′ of FIG. 1; and

FIG. 9 illustrates a cross-section II-II′ of FIG. 1.

### DETAILED DESCRIPTION OF ILLUSTRATIVE EMBODIMENTS

Because the present disclosure may have various changes and may have various example embodiments of the present disclosure, specific example embodiments are illustrated in the drawings and described in detail. However, this is not intended to necessarily limit the present disclosure to specific example embodiments, it can be understood to include all modifications, equivalents, and substitutes included in the spirit and technical scopes of the present disclosure.

Terms such as “first,” “second,” and the like, may be used to describe various elements, but the elements are not necessarily limited by such terms. Such terms can be used merely for distinguishing one component from another component. For example, a first element may be termed a second element, and similarly, a second element may be termed a first element, without departing from the scopes of the present disclosure. The term “and/or” includes a combination of a plurality of related recited items or any one of a plurality of related recited items.

Terms used in the present application can be used to describe specific example embodiments, and are not intended to necessarily limit the present disclosure. Singular expressions can include plural expressions unless the context thereof is clearly dictated otherwise. In this application, terms such as “comprise” or “having” are intended to designate that there is a feature, number, step, operation, component, parts, or a combination thereof described in the specification, but it can be understood that it does not preclude the possibility of the presence or addition of one or more other features, numbers, steps, operations, components, parts, or combinations thereof.

Unless defined otherwise, terms used herein, including technical or scientific terms, can have same meanings as can be commonly understood by one of ordinary skill in the art to which the present disclosure belongs. Terms such as those defined in a commonly used dictionary can be interpreted as having meanings consistent with meanings in the context of the related art.

In the present specification, a vehicle (including an electric vehicle) can refer to a variety of vehicles for moving an object to be transported, such as people, animals, or goods, from a starting point to a destination. These vehicles are not necessarily limited to vehicles running on roads or tracks. A vehicle can not only include a vehicle using fossil fuels such as gasoline and gasoline, but also can include a vehicle using secondary batteries using electricity stored in batteries, or the like and a vehicle using future fuels such as hydrogen.

In the description below, terms in relation to a direction in the description below such as “front,” “rear,” “lateral,” “back,” “up and down,” “above,” “upper,” “upper portion,” “upward,” “downward,” “below,” “lower,” “lower portion, “left and right,” and the like, can be based on a vehicle or a vehicle body.

Hereinafter, example embodiments of the present disclosure will be described in more detail with reference to the attached drawings.

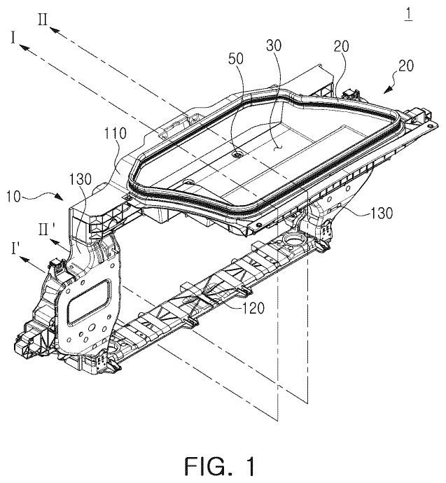

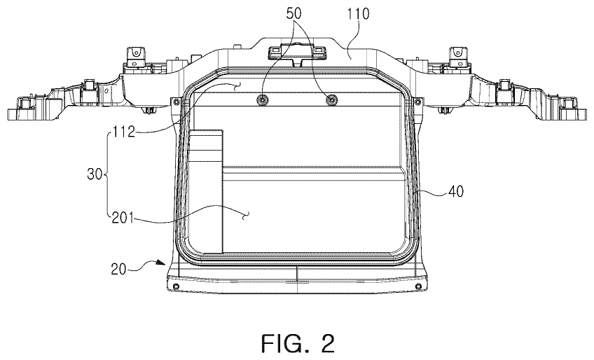

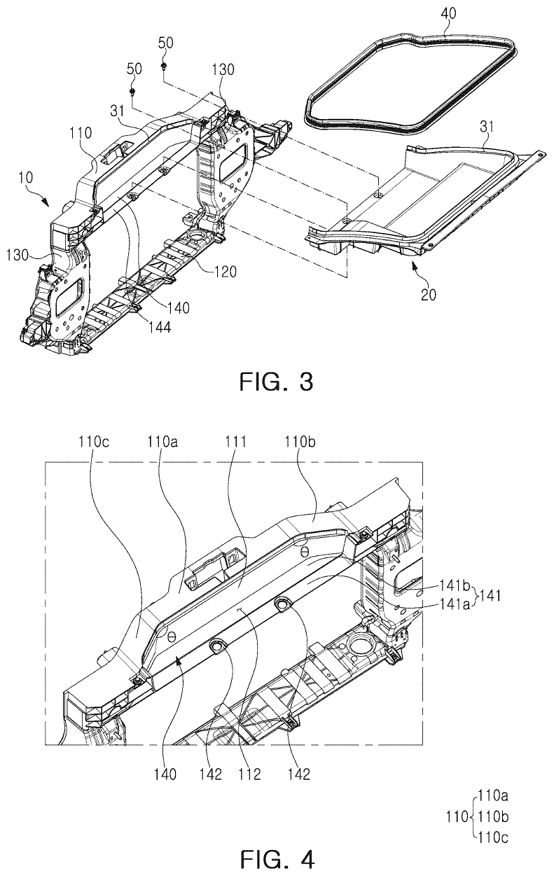

FIG. 1 is a diagram of a frunk assembly according to an embodiment of the present disclosure viewed obliquely. FIG. 2 is a diagram of a frunk assembly according to an embodiment of the present disclosure viewed from above. FIG. 3 is an exploded view of a frunk assembly according to an embodiment of the present disclosure.

Referring to FIGS. 1 to 3, a frunk assembly 1 may include a vehicle front end module 10 and a tray 20.

The front end module 10 may be disposed at the front of a vehicle body. The front end module 10 may include an upper member 110 disposed at an upper portion of the front end module 10, a lower member 120 disposed at a lower portion of the front end module 10, and a side member 130 connecting the upper member 110 and the lower member 120. The side members 130 may be provided as two thereof, and each of the two side members 130 may be disposed on one side and the other side of the upper member 110.

A plate portion 140 may be disposed on the front end module 10. The plate portion 140 may be coupled to the upper member 110, and may be manufactured separately and coupled to the upper member 110 or manufactured integrally with the upper member 110.

The tray 20 may be disposed at the rear of the front end module 10. The tray 20 may be disposed at the rear of the upper member 110, and at least a portion of the tray 20 may be disposed facing at least a portion of the upper member 110. The tray 20 may be coupled to the plate portion 140, and the tray 20 coupled to the plate portion 140 may form a receiving portion 30 for receiving cargo together with the upper member 110.

A sealing member 40 may be disposed in the frunk assembly 1. The sealing member 40 may be disposed along the periphery of the receiving portion 30. A protrusion may be disposed around the receiving portion 30. The protrusion 31 may formed of a structure extending along the periphery of the receiving portion 30. The sealing member 40 may be coupled to the protrusion 31 to form a structure surrounding the periphery of the receiving portion 30.

For the frunk assembly 1 mounted on a vehicle to function properly as a way of loading and storing cargo, a cover member (not shown) may be disposed on an upper portion of the receiving portion 30. The cover member may be configured independently, but may alternatively be a portion of a hood of the vehicle. A sealing member 40 may be disposed between the frunk assembly 1 and the cover member to prevent water or foreign substances from entering the receiving portion 30 of the frunk assembly 1.

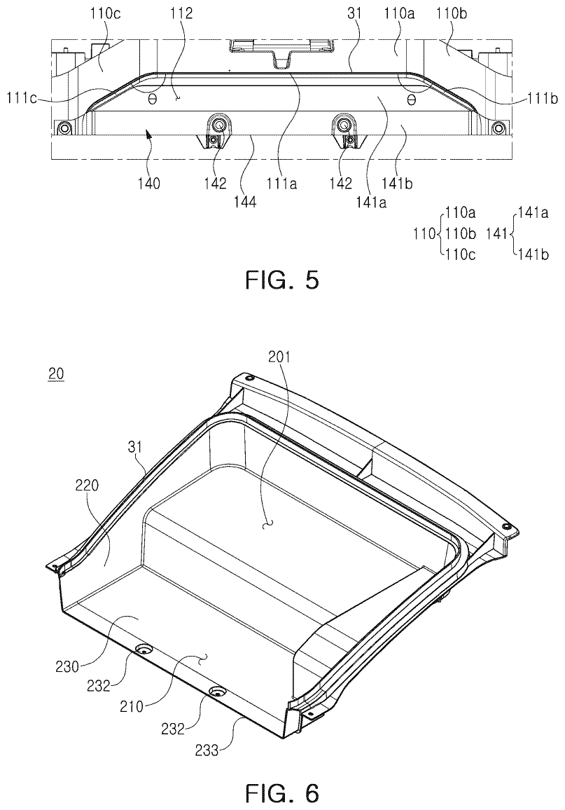

FIG. 4 is an enlarged diagram of an upper portion of the front end module in FIG. 3. FIG. 5 is a diagram of a part of the upper member of the front end module of FIG. 3 viewed from above.

Referring to FIGS. 4 and 5, an upper member 110 may have a structure extending in a width direction of a vehicle body. Specifically, the upper member 110 may have a structure similar to a bent bar, and a plate portion 140 may be coupled to a lower portion of the upper member 110.

A front portion of the upper member 110 may protrude. A back portion 111 of the upper member 110, which is a rear portion of the upper member 110, may be concavely bent toward the front of the upper member 110. The upper member 110 may include a first member 110a, a second member 110b, and a third member 110c. The first member 110a to the third member 110c may be formed separately and joined or coupled, but the first member 110a to the third member 110c may also be formed integrally.

The first member 110a may extend in a longitudinal direction of the upper member 110.

A second member 110b may be disposed on one side of the first member 110a. The second member 110b may extend from the first member 110a. The second member 110b can form an obtuse angle with the first member 110a. When viewed from above the upper member, a back portion 111b of the second member 110b and a back portion 111b of the first member 110a may be disposed at an obtuse angle.

A third member 110c may be disposed on the other side of the first member 110a. The third member 110c may be extended from the first member 110a. The third member 110c may form an obtuse angle with the first member 110a. When viewed from above the upper member 110, the back portion 111c of the third member 110c and the back portion 111b of the first member 110a may be disposed at an obtuse angle.

Accordingly, the back portion 111b of the second member 110b and the back portion 111c of the third member 110c may be further apart from the front to the rear of the front end module 10.

A space portion 112 is formed between the first member 110a, the second member 110b, and the third member 110c, and the space portion 112 may be a portion of the receiving portion 30 of the frunk assembly 1.

A plate portion 140 may be coupled to a lower portion of the upper member 110. The plate portion 140 may be disposed to form a step portion with an upper surface 141 of the upper member 110. The plate portion 140 may be coupled to the first member 110a, the second member 110b, and the third member 110c. The plate portion 140 may be integral with the first member 110a, the second member 110b, and the third member 110c. The plate portion 140 may be disposed below a space portion formed by the first member 110a, the second member 110b, and the third member 110c.

The upper surface 141 of the plate portion 140 may include a first upper surface 141a and a second upper surface 141b. The first upper surface 141a and the second upper surface 141b may be disposed parallel to each other. The first upper surface 141a may be a surface extending in a direction parallel to a longitudinal direction of the first member 110a. The second upper surface 141b may be a surface extending in a direction parallel to the longitudinal direction of the first member 110a. The first upper surface 141a may be a surface disposed closer to the first member 110a than to the second upper surface 141b. A bolt joint portion 142 may be disposed the plate portion 140. A bolt joint portion 142 may be disposed on the second upper surface 141b of the plate portion 140. A plurality of bolt joint portions 142 disposed on the plate portion 140 may be disposed, and the plurality of bolt joint portions 142 may be disposed to be spaced apart from each other in a longitudinal direction of the second upper surface 141b.

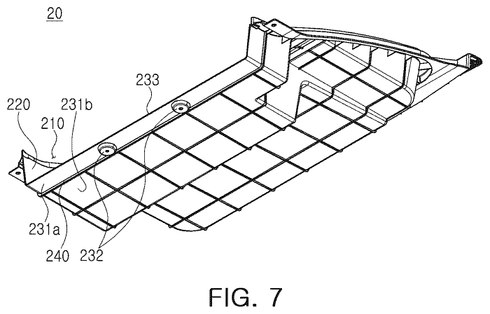

FIG. 6 is a diagram of a tray according to an embodiment of the present disclosure viewed obliquely. FIG. 7 is a diagram of a tray according to an embodiment of the present disclosure viewed obliquely from a different angle than FIG. 6.

A tray 20 may include a lower portion 230 and a side wall portion 220. The lower portion 230 of the tray 20 may be a portion forming the bottom of the tray. The side wall portion 220 may be disposed along a portion of an edge of the lower portion 230.

An opening 210 may be disposed at the front of the tray 20. That is, the side wall portion 220 may be omitted at the front of the tray 20.

A space portion 201 formed by the side wall portion 220 and the lower portion 230 may be disposed in the tray 20. The space portion 201 of the tray may form a receiving portion 30 of the tray 20 together with the space portion 112 of the upper member 110 described above. To help understanding, if the space portion 201 of the tray 20 is referred to as a first space portion 201, and the space portion 112 of the upper member 110 is referred to as a second space portion 112, the first space portion 201 and the second space portion 112 may be connected to each other for communication therewith to form a receiving portion 30.

A stopper 240 may be disposed on a lower surface of the tray 20. The stopper 240 may extend in a width direction of the tray. The lower surface of the tray 20 with the stopper 240 as a boundary may be distinguished into a first lower surface 231a and a second lower surface 231b. The first lower surface 231a may refer to a surface disposed at the front of the stopper 240, and the second lower surface 231b may refer to a surface disposed at the rear of the stopper 240.

A bolt joint portion 232 may be disposed on a lower portion 230 of the tray 20. The bolt joint portion 232 may be disposed on the first lower surface 231a. A bolt joint portion 232 disposed on the lower portion of the tray may be disposed to correspond to the bolt joint portion 142 disposed on a second upper surface 141b of the plate portion 140. A bolt joint portion 232 disposed on the first lower surface 231a may be disposed in plural, and may be disposed to be spaced apart in a longitudinal direction of the first lower surface 231a.

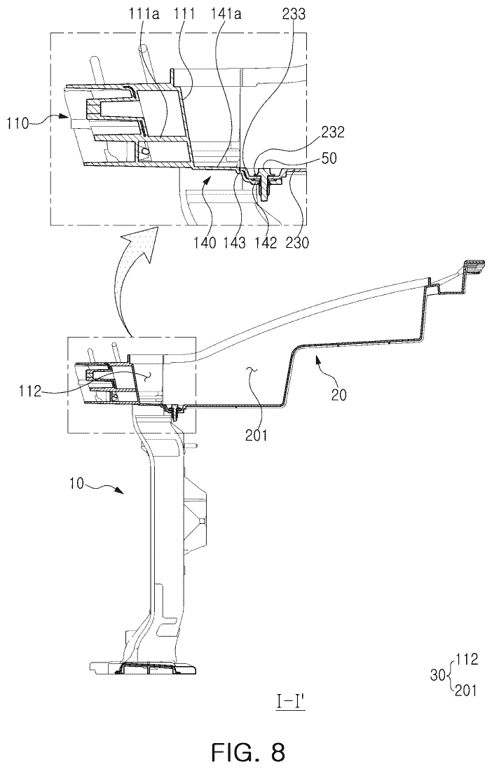

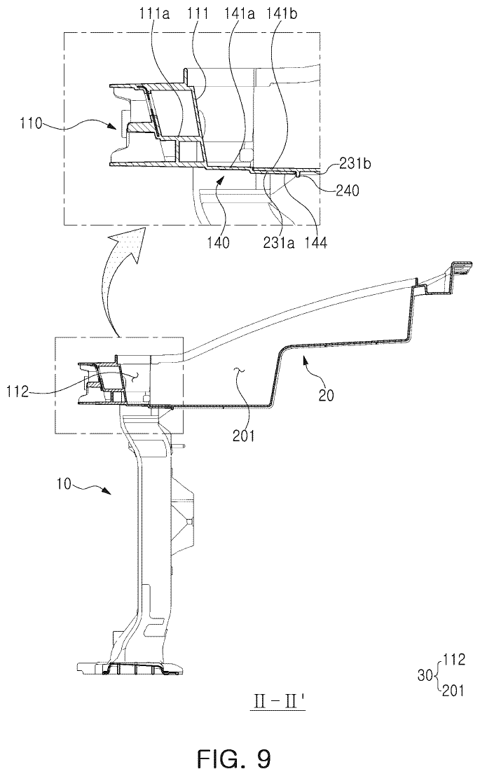

FIG. 8 illustrates a cross-section I-I of FIG. 1. FIG. 9 illustrates a cross-section II-II′ of FIG. 1. A joint structure of a front end module 10 and a tray 20 will be specifically described with reference to FIGS. 8 and 9.

A second upper surface 141b of a plate portion 140 and a first lower surface 231a of a tray 20 may be disposed facing each other. The second upper surface 141b and the first lower surface 231a may be disposed to be in contact with each other.

A bolt joint portion 142 of the plate portion 140 may be referred to as a first bolt joint portion 142, and a bolt joint portion 232 of the lower portion 230 of the tray 20 may be referred to as a second bolt joint portion 232. The first bolt joint portion 142 and the second bolt joint portion 232 may be disposed in corresponding positions. The bolt 50 may be connected by penetrating both the first bolt joint portion 142 and the second bolt joint portion 232. The bolt 50 may be inserted from an upper portion to a lower portion of the tray 20. That is, a head of the bolt 50 may be disposed above the lower portion 230 of the tray 20. The bolt 50 may fasten an upper portion to a lower portion by a dispositional structure of the bolt 50, making it easy to perform a fastening operation of the bolt 50.

A step portion 143 may be disposed on the plate portion 140. Specifically, a first upper surface 141a of the plate portion 140 may be disposed above a second upper surface 141b, and a step portion 143 can be disposed between the first upper surface 141a and the second upper surface 141b.

The step portion 143 may face an end 233 of the lower portion 230 of the tray 20. In some cases, the step portion 143 may contact the end 233 of the lower portion 230 of the tray 20. The step portion 143 may prevent the tray 20 coupled to the plate portion 140 from being pushed forward.

The end 144 of the plate portion 140 may face a stopper 240 disposed on a lower surface 231 of the tray 20. In some cases, the stopper 240 may be in contact with the end 144 of the plate portion 140. The stopper 240 may prevent the tray 20 coupled to the plate portion 140 from being pushed forward.

A back portion 111 of an upper member 110 may include a wall structure. A rib 111a may be disposed on the back portion 111, which can have a wall structure. The rib 111a may protrude toward the front of the back portion 111. The rib 111a may reinforce the rigidity of the upper member 110. The back portion 111 of the upper member 110 may form an inner wall of a receiving portion 30 together with a side wall portion 220 of the tray 20. That is, because the back portion 111 of the upper member 110 is formed as a wall structure, cargo may be loaded into the receiving portion 30 without disposing a separate cover member in the receiving portion 30. Because the back portion 111 of the upper member 110 can be formed as a wall structure, a groove or hole structure can be not formed in back portion 111 of the upper member 110, so that small cargo may be prevented from being separated from the receiving portion 30 through the groove or hole structure in the receiving portion 30.

Because the frunk assembly 1 according to an embodiment of the present disclosure may use space at the rear of the upper member 110 of the front end module 10 as the receiving portion 30 of the frunk, it can be possible to secure a wide receiving portion 30 within the limited space of a vehicle body. Because the receiving portion 30 of the frunk may be disposed close to the front of the vehicle body, user convenience can also be increased. When assembling the front end module 10 and the tray 20, the bolt 50 may be fastened from the upper portion to the lower portion, making the assembly operation easier.

As set forth above, according to an embodiment of the present disclosure, because a frunk assembly may use space at the rear of an upper member of a front end module as a receiving portion of a frunk, a wide receiving portion within the limited space of a vehicle body may be secured. Because the receiving portion of the frunk may be disposed closer to the front of the vehicle body, user convenience may also be increased.

The advantages of an embodiment of the present disclosure are not necessarily limited to those described above, and other advantages not mentioned can be clearly recognized by those skilled in the art from the description below.

While example embodiments have been illustrated and described above, it can be apparent to those skilled in the art that modifications, equivalents, and variations can be made without departing from the scopes of the present disclosure as defined by the appended claims.

What is claimed is:

1. A frunk assembly, comprising:
an upper member disposed on an upper portion of a front end module for a vehicle;
a plate portion disposed to have a step portion with an upper-member upper surface of the upper member; and
a tray having an opening disposed at a tray front thereof, wherein a lower portion of the tray is coupled to the plate portion, wherein a back portion of the upper member facing the opening is bent toward an upper member front of the upper member, and wherein the back portion of the upper member and the tray form a receiving portion.

2. The frunk assembly of claim 1, wherein a tray end of the lower portion of the tray is spaced apart from at least a portion of the back portion in a first direction, and wherein the first direction is a direction intersecting a longitudinal direction of the upper member.

3. The frunk assembly of claim 2, wherein a lower surface of the lower portion of the tray is in contact with a plate-portion upper surface of the plate portion.

4. The frunk assembly of claim 1, wherein the back portion of the upper member includes a wall structure.

5. The frunk assembly of claim 1, wherein a rib protruding toward a back-portion front of the back portion is disposed in the back portion.

6. The frunk assembly of claim 4, wherein the tray includes a side wall portion, and wherein the back portion and the side wall portion form an inner surface of the receiving portion.

7. The frunk assembly of claim 1, wherein a plate-portion upper surface of the plate portion comprises:
a first upper surface;
a second upper surface disposed at a rear of the first upper surface; and
a step portion between the first upper surface and the second upper surface, wherein the lower portion of the tray is coupled to the second upper surface.

8. The frunk assembly of claim 1, further comprising a sealing member having elasticity disposed along a periphery of the receiving portion.

9. The frunk assembly of claim 8, wherein a protrusion extending along the periphery of the receiving portion, wherein the protrusion is fitted into and coupled with the sealing member.

10. A frunk assembly, comprising:
an upper member disposed on an upper portion of a front end module for a vehicle; and
a tray disposed facing the upper member and coupled to the front end module, wherein the upper member comprises:
a first member,
a second member disposed on a first side of the first member, and
a third member disposed on a second side of the first member, wherein a space between the first member, the second member, and the third member forms a receiving portion together with the tray.

11. The frunk assembly of claim 10, wherein the first member and the second member are disposed at a first obtuse angle, and wherein the first member and the third member are disposed at a second obtuse angle.

12. The frunk assembly of claim 10, wherein a joint portion of the tray and the front end module is lower than an upper surface of the upper member.

13. A frunk assembly for a vehicle, comprising:
a first frunk portion comprising a concave part of an upper member of a structural front end module of the vehicle; and
a second frunk portion comprising a concave tray, such that the first frunk portion and the second frunk portion together define a storage volume for the frunk assembly.

14. The frunk assembly of claim 13, wherein the concave tray comprises:
two tray sidewalls,
a tray back wall, and
a tray bottom connecting between the two tray sidewalls and connecting with the tray back wall;
wherein the concave part of the upper member comprises:
an upper-member front wall, and
an upper-member bottom plate connected with the upper-member front wall, such that the upper-member bottom plate is lower than an upper-member top surface of the upper member; and
wherein the two tray sidewalls, the tray back wall, the tray bottom, the upper-member front wall, and the upper-member bottom plate, together define the storage volume for the frunk assembly.

15. The frunk assembly of claim 14, wherein the upper-member bottom plate comprises:
a first upper surface thereof,
a second upper surface thereof disposed rearward of the first upper surface, and
a step portion between the first upper surface and the second upper surface, wherein the second upper surface is lower than the first upper surface; and
wherein the tray bottom comprises a lower tray surface at a tray front end of the concave tray; and
wherein the lower tray surface at the tray front end of the concave tray interfaces with and contacts the second upper surface of the upper member.

16. The frunk assembly of claim 14, further comprising:
a first protruding ridge extending upward from the two tray sidewalls and the tray back wall;
a second protruding ridge extending upward from the upper-member front wall, such that the first protruding ridge together with the second protruding ridge extend around an upper perimeter of the storage volume at an upper end of the storage volume; and
an elastic sealing member fitted on the first protruding ridge and the second protruding ridge along the upper perimeter.

17. The frunk assembly of claim 13, wherein the upper member comprises:
a first structural beam extending horizontally in a width direction of the vehicle;
a second structural beam extending diagonally rearward from a left side of the first structural beam, and
a third structural beam extending diagonally rearward from a right side of the first structural beam, wherein the first structural beam, the second structural beam, and the third structural beam together are at least part of an upper-member front wall of the first frunk portion as part of the concave part of the upper member.

18. The frunk assembly of claim 17, wherein the upper member further comprises an upper-member bottom plate extending from the first structural beam, the second structural beam, and the third structural beam, wherein the upper-member bottom plate is lower than an upper-member top surface of the upper member, and wherein the upper-member bottom plate is connected with the upper-member front wall, and wherein the concave part of the upper member comprises the upper-member bottom plate and the upper-member front wall together.

19. The frunk assembly of claim 18, wherein the upper-member bottom plate comprises:
a first upper surface thereof,
a second upper surface thereof disposed rearward of the first upper surface, and
a step portion between the first upper surface and the second upper surface, wherein the second upper surface is lower than the first upper surface;
wherein the concave tray comprises a tray bottom, wherein the tray bottom comprises a lower tray surface at a tray front end of the concave tray; and
wherein the lower tray surface at the tray front end of the concave tray interfaces with and contacts the second upper surface of the upper member.

20. The frunk assembly of claim 19, wherein the concave tray further comprises a stopper protruding downward from the lower tray surface at a spaced distance from the tray front end.
